(19) United States
(12) Patent Application Publication
(10) Pub. No.: US 2026/0030026 A1
(43) Pub. Date: Jan. 29, 2026

(54) PREDICTIVELY FETCHING A BRANCH BASED ON A FETCH GROUP ADDRESS AND BRANCH HISTORY EARLY IN AN INSTRUCTION FETCH CIRCUIT

(71) Applicant: QUALCOMM Incorporated, San Diego, CA (US)

(72) Inventor: Ajay Kumar Rathee, San Jose, CA (US)

(21) Appl. No.: 18/782,772

(22) Filed: Jul. 24, 2024

(51) Int. Cl. G06F 9/38

(52) U.S. Cl. CPC G06F 9/3804; G06F 9/3806; G06F 9/3808; G06F 9/3844

(57) ABSTRACT

Aspects include predictively fetching branches based on a fetch group address and branch history early in an instruction fetch circuit. The fetch group address comprises a plurality of instructions which are fetched together, in parallel, from an instruction cache by the fetch instruction circuit. A processor-based device provides the fetch group address, a branch history, and an instruction processing circuit configured to process an instruction stream in an instruction pipeline. The instruction processing circuit comprises the instruction fetch circuit configured to, in response to the fetch group address and the branch history, generate a target address for a fetch group, the fetch group comprising a plurality of fetched instructions from the instruction stream, wherein the target address is a predicted-taken branch. To this end, this branch prediction takes place early in the instruction fetch circuit, thus, decreasing the likelihood of pipeline stalls while also improving the performance of branch prediction.

### TECHNICAL FIELD

The technology of the disclosure relates generally to predictively fetching instructions in a processor-based system, and, in particular, to improving branch prediction.

### BACKGROUND

Conventional processors may employ a processing technique known as instruction pipelining, whereby the throughput of computer instructions being executed may be increased by dividing the processing of each instruction into a series of steps which are then executed within an execution pipeline composed of multiple stages. Optimal processor performance may be achieved if all stages in an execution pipeline are able to process instructions concurrently and sequentially as the instructions are ordered in the execution pipeline. However, the performance of a conventional processor is limited by the fetch performance of the processor's “front end,” which refers generally to the portion of the processor that is responsible for fetching and preparing instructions for execution.

The front-end architecture of the processor may employ a number of different approaches for improving fetch performance. One approach involves using a conditional branch predictor (CBP) to speculatively predict a path to be taken by a branch instruction (based on, e.g., the results of previously executed branch instructions), and basing the fetching of subsequent instructions on the branch prediction. When the branch instruction reaches the execution stage of the processor's instruction pipeline and is executed, the resulting target address of the branch instruction is verified by comparing it with the previously predicted target address when the branch instruction was fetched. If the predicted and actual target addresses match (i.e., the branch prediction was correct), instruction execution can proceed without delay because the subsequent instructions at the target address will have already been fetched and will be present in the instruction pipeline. In particular, the CBP may utilize a branch target buffer (BTB) early in the fetch instruction circuit to predict whether a fetch group has a taken branch in it. The fetch group is a basic block of a number of instructions fetched in an instruction stream. The size of the fetch group is an exponent of two (2) such as 8, 16, 32, 64 and so on. The BTB stores tags representative of previous fetch group program counters and returns a corresponding target address for the next fetch group program counter that includes a taken branch. The BTB lookup is typically performed in the first cycle of the instruction fetch circuit.

To further improve the prediction performance of the processor, an instruction processing circuit of the processor may use predictions based on branch history accessed later in an instruction pipeline circuit when a taken or non-taken branch of a specific branch instruction can be verified based on the address of the specific branch instruction. Although the prediction performance may be improved, the delay for verifying and predicting the taken branch later in the pipeline based on history may cause stalls in the instruction pipeline.

### SUMMARY OF THE DISCLOSURE

Aspects disclosed in the detailed description include predictively fetching branches based on a fetch group address and branch history early in an instruction fetch circuit. The fetch group address comprises a plurality of instructions which are fetched together, in parallel, from an instruction cache by the instruction fetch circuit. Related apparatus, methods, and computer-readable media are also disclosed. In this regard, in some exemplary aspects disclosed herein, a processor-based device provides the fetch group address, a branch history, and an instruction processing circuit configured to process an instruction stream in an instruction pipeline. The instruction processing circuit comprises the instruction fetch circuit configured to, in response to the fetch group address and the branch history, generate a target address for a fetch group, the fetch group comprising a plurality of fetched instructions from the instruction stream, wherein the target address is a predicted-taken branch. A predicted not-taken branch is merely an increment of a fetch group program counter to the next fetch group address. To this end, by being responsive to the fetch group address and the branch history, the processor-based device disclosed herein advantageously predictively fetches branches before a branch instruction corresponding to an address in the fetch group is fully decoded. This branch prediction takes place carly in the instruction fetch circuit, thus decreasing the likelihood of pipeline stalls while also improving the performance of branch prediction.

In one aspect, a processor-based device is disclosed. The processor-based device comprises a fetch group address of a fetch group, the fetch group comprising a group of instructions to be fetched where one of the group of instructions is a branch instruction, a global branch history, and a history-based branch target buffer (HBTB). The processor-based device also comprises an instruction processing circuit configured to process an instruction stream. The instruction processing circuit comprises an instruction fetch circuit, in response to the fetch group address and the global branch history, configured to index into the HBTB and determine whether there is a hit in the HBTB. In response to the hit in the HBTB, the instruction fetch circuit is further configured to retrieve a target address for a next fetch group. The next fetch group comprises a plurality of fetched instructions from the instruction stream, wherein one of the plurality of fetched instructions is a predicted-taken branch of the branch instruction.

In another aspect, a processor-based device is disclosed. The processor-based device comprises a fetch group address of a fetch group, the fetch group comprising a group of instructions to be fetched where one of the group of instructions is a branch instruction, a global branch history, a history-based branch target buffer (HBTB), and a means for processing an instruction stream. The means for processing the instruction stream, in response to the fetch group address and the global branch history, comprises a means for indexing into the HBTB, and a means for determining whether there is a hit in the HBTB. In response to the hit in the HBTB, the means for processing the instruction stream further comprises a means for retrieving a target address for a next fetch group. The next fetch group comprises a plurality of fetched instructions from the instruction stream, wherein one of the plurality of fetched instructions is a predicted-taken branch of the branch instruction.

In another aspect, a method for predictively fetching branches based on a fetch group address and branch history is disclosed. The method comprises providing the fetch group address of a fetch group, the fetch group comprising a group of instructions to be fetched where one of the group of instructions is a branch instruction, providing a global branch history, providing a history-based branch target buffer (HBTB), and processing an instruction stream. In response to the fetch group address and the global branch history, the method further comprises indexing into the HBTB, determining whether there is a hit in the HBTB, and retrieving a target address for a next fetch group. The next fetch group comprising a plurality of fetched instructions from the instruction stream, wherein one of the plurality of fetched instructions is a predicted taken branch of the branch instruction.

### BRIEF DESCRIPTION OF THE FIGURES

FIG. 1 is a block diagram of an exemplary processor-based device that includes a processor with an instruction processing circuit that includes an instruction fetch circuit that predictively fetches branches based on a fetch group address and branch history, according to some aspects;

FIG. 2 is a timing stage diagram of the instruction fetch circuit of FIG. 1 illustrating the prediction of a target address for a branch instruction in a fetch group early in the processing of the instruction fetch circuit;

FIG. 3 is a control flow diagram of an exemplary instruction stream which is processed by the instruction fetch circuit of FIG. 1;

FIG. 4A is a block diagram of an exemplary history-based branch target buffer (HBTB) of FIG. 1 illustrating the indexing into the HBTB for the exemplary instruction stream of FIG. 3;

FIG. 4B is a block diagram of an exemplary confidence threshold register of the instruction processing circuit of FIG. 1;

FIG. 4C is a block diagram of an exemplary branch target buffer (BTB) of FIG. 1 illustrating indexing into the BTB for the exemplary instruction stream of FIG. 3 assuming there was a miss in the HBTB;

FIG. 5 is a flowchart illustrating exemplary method for predictively fetching branches based on a fetch group address and branch history;

FIG. 6 is a flowchart illustrating exemplary operations in more detail of the instruction fetch circuit of FIG. 1 for predictively fetching a branch based on a fetch group program counter and global branch history;

FIGS. 7A-7C is a flowchart illustrating exemplary verification operations of the instruction fetch circuit in FIGS. 1-2, and more particularly, the BTB/HBTB target verification circuit in FIG. 2, to train the entries in the HBTB and BTB in FIG. 1 to predictively fetch a branch based on a fetch group program counter and global branch history; and

FIG. 8 is a block diagram of an exemplary processor-based device that can include the instruction fetch circuit of FIGS. 1 and 2, and according to the exemplary processes of FIGS. 5, 6, and 7A-7C which is configured to predictively fetch branches based on a fetch group address and branch history.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include predictively fetching branches based on a fetch group address and branch history early in an instruction fetch circuit. The fetch group address comprises a plurality of instructions which are fetched together, in parallel, from an instruction cache by the instruction fetch circuit. Related apparatus, methods, and computer-readable media are also disclosed. In this regard, in some exemplary aspects disclosed herein, a processor-based device provides the fetch group address, a branch history, and an instruction processing circuit configured to process an instruction stream in an instruction pipeline. The instruction processing circuit comprises the instruction fetch circuit configured to, in response to the fetch group address and the branch history, generate a target address for a fetch group, the fetch group comprising a plurality of fetched instructions from the instruction stream, wherein the target address is a predicted-taken branch. A predicted not-taken branch is merely an increment of a fetch group program counter to the next fetch group address. To this end, by being responsive to the fetch group address and the branch history, the processor-based device disclosed herein advantageously predictively fetches branches before a branch instruction corresponding to an address in the fetch group is fully decoded. This branch prediction takes place carly in the instruction fetch circuit, thus, decreasing the likelihood of pipeline stalls while also improving the performance of branch prediction.

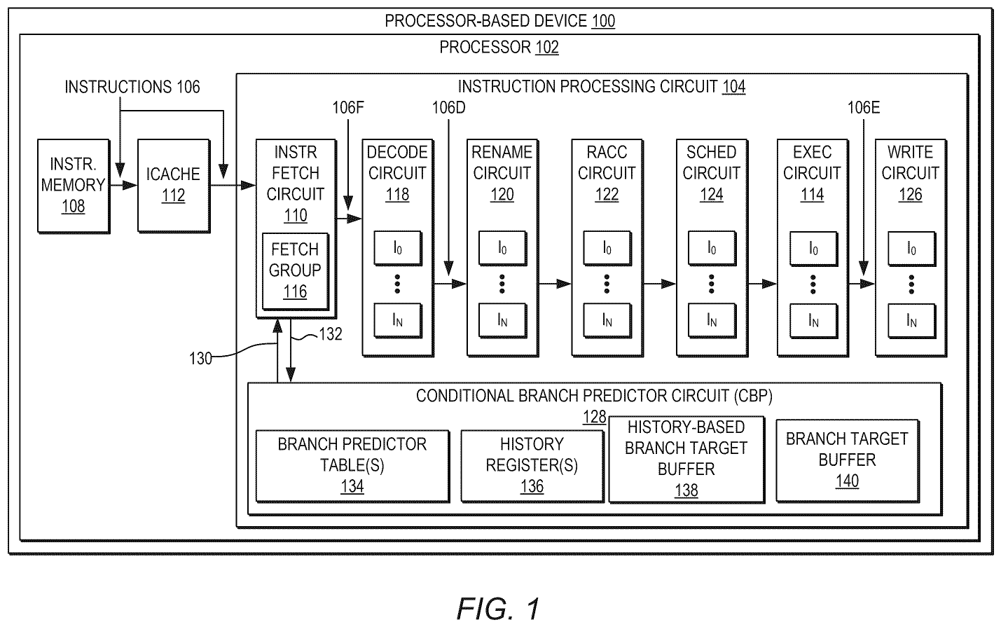

In this regard, FIG. 1 is a block diagram of an exemplary processor-based device 100 that includes a processor 102 with an instruction processing circuit 104 that includes an instruction fetch circuit that predictively fetches branches based on a fetch group address and branch history. The processor 102, which also may be referred to as a “processor core” or a “central processing unit (CPU) core,” may be an in-order or an out-of-order processor (OoP), and/or may be one of a plurality of processors 102 provided by the processor-based device 100. In the example of FIG. 1, the processor 102 includes the instruction processing circuit 104 that includes one or more instruction pipelines I₀-I_{N} for processing instructions (also referred to as an instruction stream) 106 fetched from an instruction memory (captioned “INSTR MEMORY” in FIG. 1) 108 by an instruction fetch circuit (captioned “INSTR FETCH CIRCUIT” in FIG. 1) 110 for execution. The instruction memory 108 may be provided in or as part of a system memory in the processor-based device 100, as a non-limiting example. An instruction cache (captioned “ICACHE” in FIG. 1 or Icache in the description) 112 may also be provided in the processor 102 to cache the instructions 106 fetched from the instruction memory 108 to reduce latency in the instruction fetch circuit 110.

The instruction fetch circuit 110 in the example of FIG. 1 is configured to provide the instructions 106 as fetched instructions 106F into the one or more instruction pipelines I₀-I_{N} in the instruction processing circuit 104 to be pre-processed, before the fetched instructions 106F reach an execution circuit (captioned “EXEC CIRCUIT” in FIG. 1) 114 to be executed. The instruction pipelines lo-Ix are provided across different processing circuits or stages of the instruction processing circuit 104 to pre-process and process the fetched instructions 106F in a series of steps that can be performed concurrently to increase throughput prior to execution of the fetched instructions 106F by the execution circuit 114. When fetching instructions, the instruction fetch circuit 110 may use a fetch group program counter (not shown) which periodically increments to provide a target address of a fetch group 116 comprising a plurality of instructions (not shown) for processing. The use of the fetch group 116 may better enable the instruction fetch circuit 110 to provide instructions to subsequent stages of the instruction processing circuit at a pace sufficient to maximize the throughput of the instruction processing circuit 104 and minimize wasted processor cycles.

With continuing reference to FIG. 1, the instruction processing circuit 104 includes a decode circuit 118 configured to decode the fetched instructions 106F fetched by the instruction fetch circuit 110 into decoded instructions 106D to determine the instruction type and actions required. The instruction type and action required encoded in the decoded instructions 106D may also be used to determine in which instruction pipeline I₀-I_{N} the decoded instructions 106D should be placed. In this example, the decoded instructions 106D are placed in one or more of the instruction pipelines I₀-I_{N} and are next provided to a rename circuit 120 in the instruction processing circuit 104. The rename circuit 120 is configured to determine if any register names in the decoded instructions 106D should be renamed to decouple any register dependencies that would prevent parallel or out-of-order processing.

The instruction processing circuit 104 in the processor 102 in FIG. 1 also includes a register access circuit (captioned “RACC CIRCUIT” in FIG. 1) 122. The register access circuit 122 is configured to access a physical register in a physical register file (PRF) (not shown) based on a mapping entry mapped to a logical register in a register mapping table (RMT) (not shown) of a source register operand of a decoded instruction 106D to retrieve a produced value from an executed instruction 106E in the execution circuit 114. The register access circuit 122 is also configured to provide the retrieved produced value from an executed instruction 106E as the source register operand of a decoded instruction 106D to be executed.

Also, in the instruction processing circuit 104, a scheduler circuit (captioned “SCHED CIRCUIT” in FIG. 1) 124 is provided in the instruction pipeline I₀-I_{N} and is configured to store decoded instructions 106D in reservation entries until all source register operands for the decoded instruction 106D are available. The scheduler circuit 124 issues decoded instructions 106D that are ready to be executed to the execution circuit 114. A write circuit 126 is also provided in the instruction processing circuit 104 to write back or commit produced values from executed instructions 106E to memory (such as the PRF), cache memory, or system memory.

With continuing reference to FIG. 1, the instruction processing circuit 104 also includes a conditional branch predictor circuit (CBP) 128. The CBP 128 is a circuit that is configured to speculatively predict the outcome of a fetched branch instruction that controls whether instructions corresponding to a taken path or a not-taken path in the instruction control flow path are fetched into the instruction pipelines I₀-I_{N} for execution. For example, the fetched branch instruction may be a conditional branch instruction 130 among the instructions 106 that includes a condition to be resolved by the instruction processing circuit 104 to determine which instruction control flow path (also referred to as a “branch”) should be taken. In this manner, the outcome of the conditional branch instruction 130 in this example does not have to be resolved in execution by the execution circuit 114 before the instruction processing circuit 104 can continue processing fetched instructions 106F. The prediction made by the CBP 128 can be provided as a branch prediction 132 to the instruction fetch circuit 110 to be used to determine the next instructions 106 to fetch as the fetched instructions 106F.

The CBP 128 generates branch predictions such as the branch prediction 132 using one or more branch predictor tables 134. Each of the one or more branch predictor tables 134 stores a plurality of counters (not shown) that comprise indexable entries (e.g., indexed by a hash of an address of a conditional branch instruction, a branch history, and/or a path history) comprising saturated counters that each represent a branch prediction as a signed value. The CBP 128 is configured to speculatively predict the outcome of a conditional branch instruction such as the conditional branch instruction 130 by retrieving a counter from each of multiple ones of the branch predictor tables 134, and then summing the retrieved counters, with the sign of the sum of the counters indicating the branch prediction 132. After the conditional branch instruction 130 is executed by the execution circuit 114, the results of execution of the conditional branch instruction 130 may be used to update the counters corresponding to the branch prediction 132 according to a training algorithm.

To facilitate branch prediction by the CBP 128, the one or more branch predictor tables 134 in the example of FIG. 1 are associated with corresponding one or more history registers 136. The history registers 136 are used to capture previously observed program behavior with respect to previously encountered branches, such as global branch history, path history, and the like. The CBP 128 may then correlate branch behavior with the contents of the history registers 136 when making a branch prediction based on the address of a branch instruction later in the instruction processing circuit 104. This portion of the CBP 128 generates branch predictions after knowing the particular address of the corresponding branch instruction and that the corresponding branch instruction has been decoded in order to index properly into the branch predictor tables 134.

Although the prediction by the CBP 128 described above can be accurate, it occurs in the later stages of the instruction fetch circuit 110. The prediction by the CBP 128 is enhanced by predicting branches in the earlier stages of the instruction fetch circuit 110 based on a fetch group address and branch history. In this regard, a fetch group address comprises a group of instructions to be fetched. One of the group of instructions may be a conditional branch instruction. Global branch history is included in the branch predictor table(s) 134. The instruction processing circuit 104 is configured to process an instruction stream in the instruction pipeline. The instruction processing circuit 104 includes the instruction fetch circuit 110. In response to the fetch group address and the global branch history, the instruction processing circuit 104 retrieves a target address for the next fetch group, the next fetch group comprising a plurality of fetch instructions from the instruction stream. One of the plurality of fetch instructions is a predicted-taken branch of the conditional branch instruction.

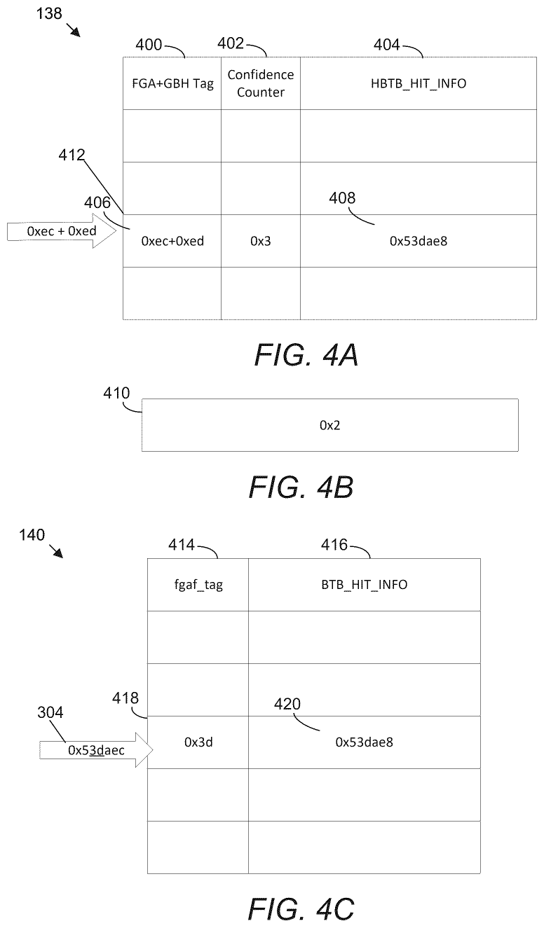

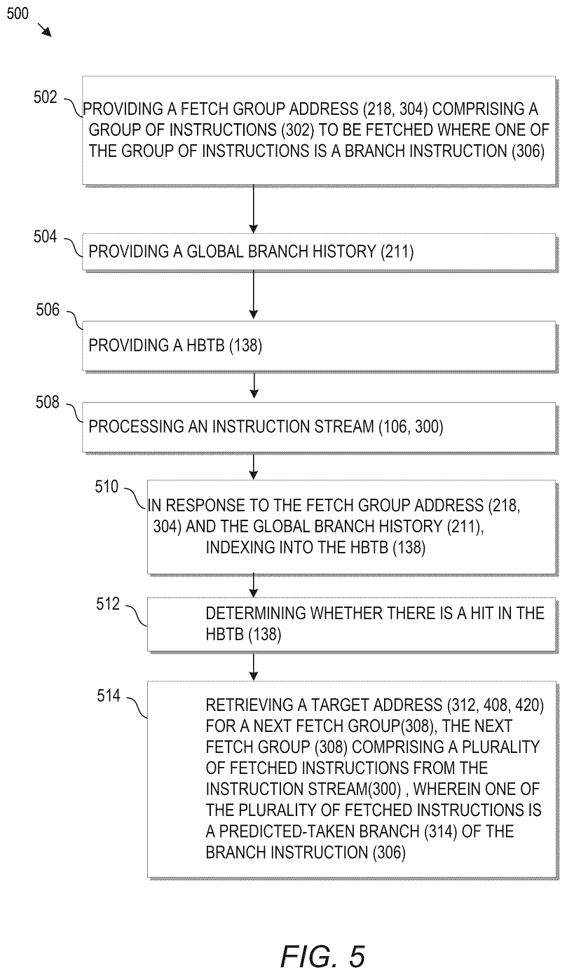

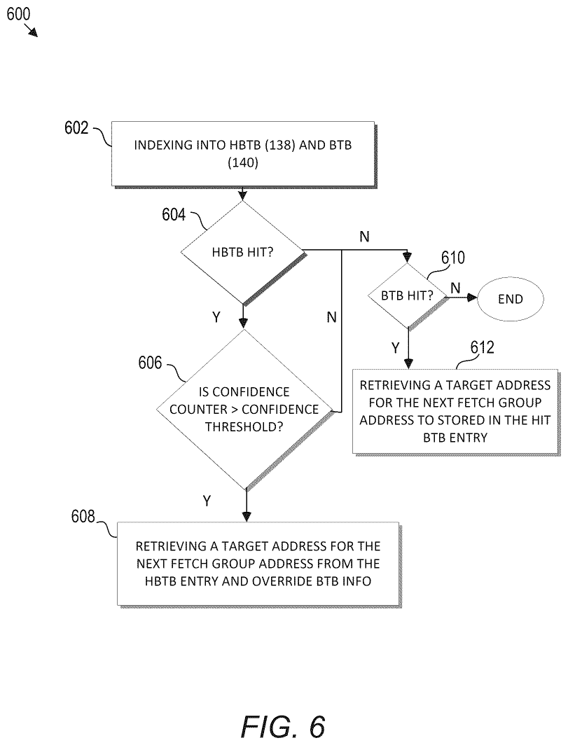

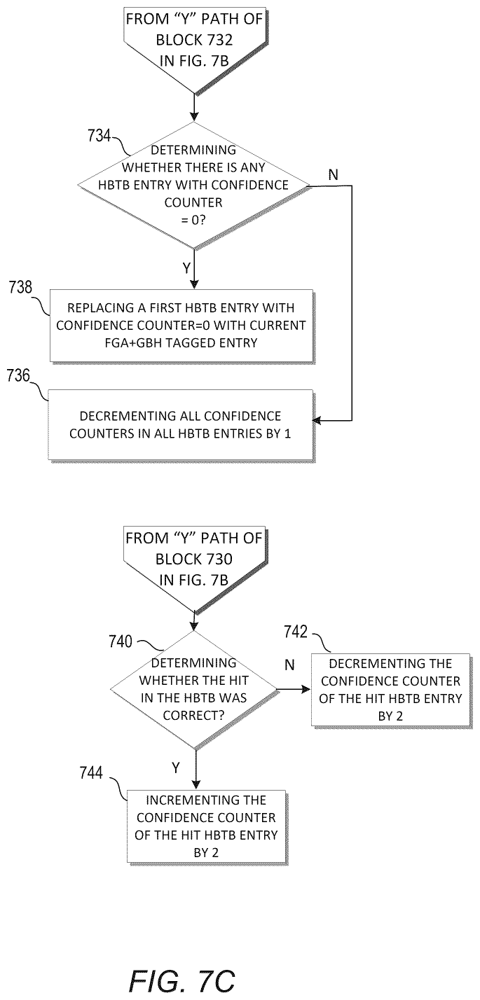

To this end, the CBP 128 provides a history-based branch target buffer (HBTB) 138 to cache additional metadata for use in conjunction with a branch target buffer (BTB) 140 when determining a target address for the next fetch group. The HBTB 138 stores indexable entries (e.g., indexed by a hash of a fetch group address containing a branch instruction, such as a conditional branch instruction, and a branch history from one of the branch predictor tables 134) comprising an address_history tag and a target address of a branch instruction within the fetch group and a saturated counter that each represent a branch prediction as a signed value. The address_history tag is a combination, such as a concatenation, of a previous fetch group address that contained a conditional branch instruction and a corresponding previous global branch history at the time an indexed entry in the HBTB 138 was allocated. Allocation of HBTB entries will be discussed in connection with FIGS. 7A-7C. In response to a fetch group address and global branch history, the instruction fetch circuit 110 determines whether the fetch group address and the global branch history match the address_history tag. When an indexed entry matches in the HBTB 138 or BTB 140, for that matter, it is referred to as a “hit.” Exemplary structure of the HBTB 138 will be discussed in more detail in connection with FIG. 4B. The BTB 140 and HBTB 138 are collectively configured to predict the outcome of a branch instruction such as the conditional branch instruction 130, in response to the fetch group address and branch history in the branch predictor table(s) 134, by indexing into the HBTB 138 and BTB 140, and retrieving a target address for a next fetch group, the next fetch group comprising a plurality of fetched instructions from the instruction stream, wherein one of the plurality of fetched instructions is a predicted-taken branch. A predicted not-taken branch is merely an increment to the fetch group program counter.

The CBP 128 also provides the BTB 140 to cache additional metadata for use in conjunction with the CBP 128 when determining a target address for a next fetch group. The BTB comprises a plurality of entries (not shown), each of which corresponds to a tag and a target address. The tag includes a portion of a previous fetch group address. The target address refers to an aligned memory block from which instructions are fetched, and each entry of the BTB stores branch metadata relating to branch instructions within that aligned memory block. The branch metadata may include, as non-limiting examples, a branch offset indicating a position of the branch instruction relative to the address of the aligned memory block, a type of branch instruction (e.g., conditional, call, indirect, and the like), and a target address of the branch instruction which will be used as the next fetch group address as opposed to incrementing the fetch group program counter. Exemplary structure of the BTB 140 will be discussed in more detail in connection with FIG. 4A.

The instruction fetch circuit 110 first determines whether there is a hit in the HBTB 138 as described above. If there is not, the instruction fetch circuit 110 determines whether the fetch group address hits in the BTB 140. If there is a hit in the BTB 140, the instruction fetch circuit 110 retrieves a target address for the next fetch group from the hit entry in the BTB 140.

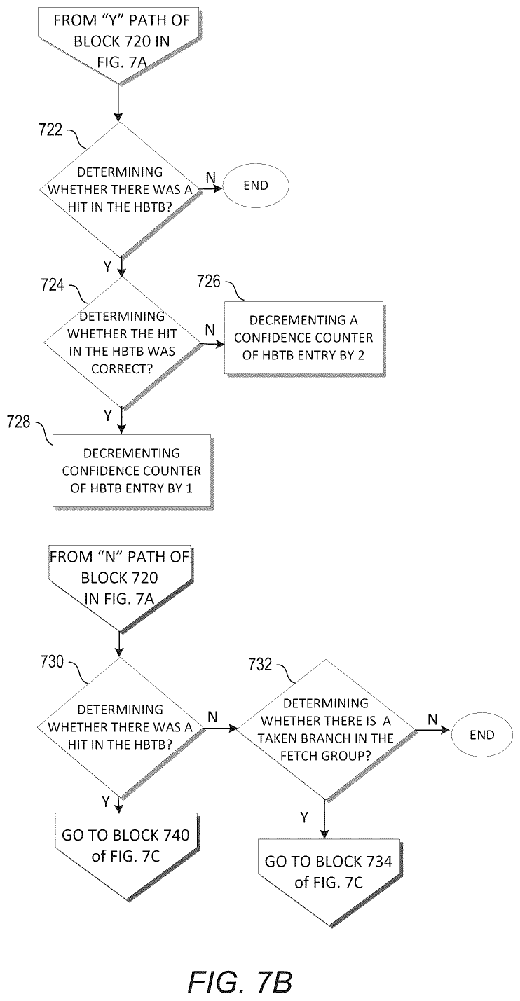

Unlike conventional instruction fetch circuits and conventional BTBs, the instruction fetch circuit 110 utilizes both the HBTB 138 and the BTB 140 to collectively predict a branch based on the fetch group address and the global branch history in the early stages of the instruction fetch circuit 110, for example, before the corresponding branch instruction is decoded, in the processing of the instruction fetch circuit 110. The HBTB 138 is much smaller than the BTB 140 and it attempts to capture branches which are hard to predict using the BTB 140. The HBTB 138 utilizes global branch history and is, thus, more accurate than predictions based on the BTB. As described above, the HBTB 138 and the BTB 140 collectively predict a branch and will be described in more detail in connection with FIG. 6. Additionally, the manner in which the entries of the HBTB 138 and BTB 140 are trained advantageously balances the size of these structures while increasing the prediction performance. FIGS. 7A-7C will discuss in more detail training of the HBTB 138 and BTB 140.

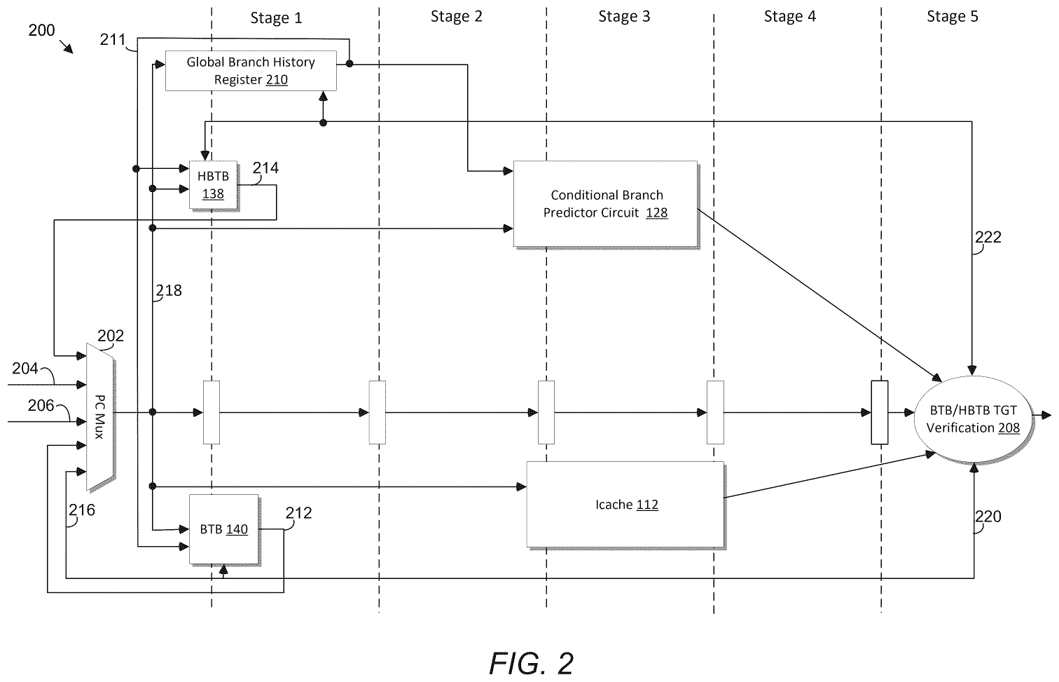

FIGS. 2 is a timing stage diagram 200 of the instruction fetch circuit 110 of FIG. 1, illustrating the prediction of a target address for a branch instruction in a fetch group carly in the processing of the instruction fetch circuit and the training paths for the BTB 140 and HBTB 138. Each stage may be one clock cycle. The instruction fetch circuit 110 includes a program counter multiplexer (PC Mux) 202 which multiplexes a next fetch group address 204 from a fetch group program counter (not shown), an executed branch redirect target 206, and various predicted branch target addresses (to be discussed) to determine which address will be the next fetch group to be processed by the instruction fetch circuit 110. The executed branch redirect target 206 is generated by the execution circuit 114. The instruction fetch circuit 110 also includes a BTB/HBTB target verification circuit 208 which verifies whether the predicted branch target from either the BTB 140 or HBTB 138 was properly predicted. The BTB/HBTB target verification circuit 208 verifies the branch target (i.e., taken or not-taken) provided by the BTB 140 or HBTB 138 when the actual branch target has been retrieved from the Icache 112 and branch prediction information is also available for the fetch group. Examples of branch prediction information includes the branch type including conditional, unconditional, direct, or indirect. The BTB/HBTB target verification circuit 208 trains the BTB 140 and HBTB 138. A global branch history register (GBHR) 210 is one of the branch predictor tables 134 and may be implemented in various manners. The GBHR 210 may store a pattern history of taken and not-taken branches or it may hold a cumulative score of all taken branches. The instruction fetch circuit 110 utilizes a value 211 stored in the GBHR 210 to index into the HBTB 138. The instruction fetch circuit 110 updates the GBHR 210 when there is a hit in the BTB 140 with a BTB predicted target address 212 for the next fetch group or there is a hit in the HBTB 138 with a HBTB predicted target address 214 for the next fetch group. The GBHR 210 is restored back to prior to a hit if the BTB/HBTB target verification circuit 208 determines that the prediction was incorrect. The PC Mux 202 also receives a BTB/HBT target redirect address 216 from the BTB/HBTB target verification circuit 208 when BTB/HBTB target verification circuit 208 determines that the target address predicted by either the BTB 140 or the HBTB 138 was incorrect.

At stage 1, a fetch group address 218 produced by the PC Mux 202 is sent to the GBHR 210, BTB 140, and HBTB 138. The instruction fetch circuit 110 utilizes the fetch group address 218 and the contents of the GBHR 210 to index into the HBTB 138. The instruction fetch circuit 110, in parallel, utilizes the fetch group address 218 to index into BTB 140. Whether there is a hit or miss in the HBTB 138 and the BTB 140, the metadata including whether there was a hit and/or, if there was a hit, whether a confidence value associated with an entry in the HBTB 138 exceeded a threshold, is carried forward through an output 220 of the BTB 140 and an output 222 of the HBTB 138 to the BTB/HBTB target verification circuit 208 for subsequent training of the HBTB 138 and BTB 140 after the fetch group associated with the fetch group address 218 is retrieved from the Icache 112. The training of the HBTB 138 and BTB 140 will be discussed in more detail in connection with FIGS. 7A-7C. The GBHR 210 is updated with the fetch group address 218 when, in the previous cycle, there was a hit in the BTB 140 or BTB 138. In that case the fetch group address 218 was the target address in the hit in the BTB 140 or BTB 138.

If there is a hit in the HBTB 138, the instruction fetch circuit 110 retrieves the predicted target address 214 from the HBTB 138 and provides it to the PC Mux 202 to be the next fetch group address. If there is not a hit (also referred to as a “miss”) in the HBTB 138, the instruction fetch circuit 110 determines whether there is a hit in the BTB 140. If there is a hit in the BTB 140, the instruction fetch circuit 110 retrieves the BTB predicted target address 212 from the BTB 140 and provides it to the PC Mux 202 to be the next fetch group address. If there is a miss in the BTB 140, the instruction fetch circuit 110 does not drive the next fetch group address from the BTB 140 or the HBTB 138. The other input to the PC Mux 202 will drive the next fetch group address such as a next fetch group address 204 from the fetch group program counter. Please note that at the point the instruction fetch circuit 110 indexes into the BTB 140 and the HBTB 138, the instructions from the fetch group have not yet been retrieved from the Icache 112. At this point, the instruction fetch circuit 110 is merely driving the next fetch group addresses to predictively fetch one of a taken and not-taken branch in an early stage in the instruction fetch circuit 110.

At stages 2 and 3, a fetch group address 218 is provided to the CBP 128 and the Icache 112. At stages 2 and 3, the instruction fetch circuit 110 retrieves the fetch group of instructions associated with the fetch group address 218 from the Icache 112. The CBP 128 determines predictions on an individual branch instruction from the fetch group fetched from the Icache 112 to determine a prediction of a taken or not-taken branch. Due to the instruction granularity, a higher level of prediction can be achieved. At stage 5, the BTB/HBTB target verification circuit 208 utilizes the branch prediction information the CBP 128 typically uses for prediction to verify the branch target (i.e., taken or not-taken) provided by the BTB 140 or HBTB 138 (which is based on a fetch group granularity) when the actual branch target has been retrieved from the Icache 112 and branch prediction information is also available for the fetch group. Regardless of whether there is a hit, the outputs 220, 222 of the BTB/HBTB target verification circuit 208 are used to train (i.e., allocate and update) the BTB 140 and the HBTB 138, respectively. FIGS. 7A-7C will discuss in more detail training of the BTB 140 and HBTB 138. At the end of stage 5, the instruction processing circuit 104 provides the fetched instructions 106F into the one or more instruction pipelines I₀-I_{N} in the instruction processing circuit 104 to be pre-processed.

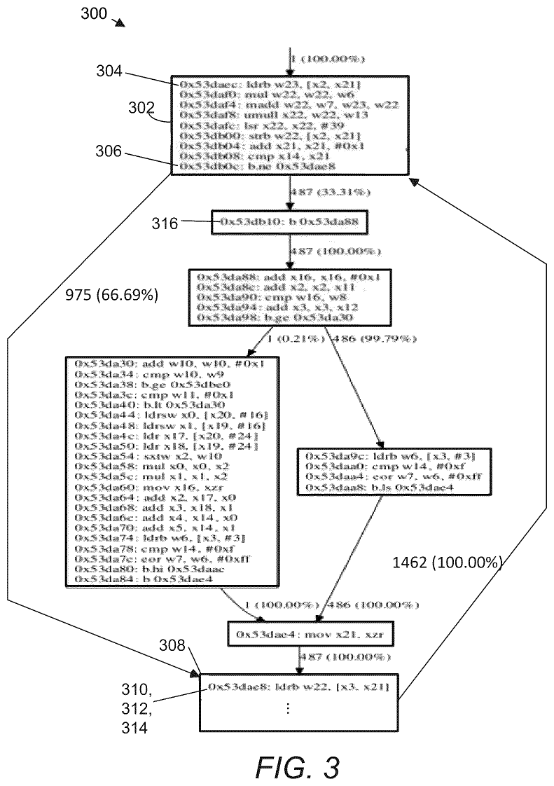

FIG. 3 is a control flow diagram of an exemplary instruction stream 300 which is processed by the instruction fetch circuit 110 of FIG. 1. FIG. 3 will be discussed in connection with FIGS. 4A and 4B to illustrate how the instruction fetch circuit 110 indexes into the HBTB 138 and BTB 140. The instruction stream 300 includes a fetch group 302. The fetch group 302 includes a fetch group address 304 which is 0x53daec. The fetch group 302 also includes a branch instruction, and in this example, a conditional branch instruction 306 at address 0x53db0c. The conditional branch instruction 306 may branch to address 0x53dac8 if the condition of the conditional branch instruction 306 evaluates as true. Prior to evaluation, the instruction fetch circuit 110 may hit in the HBTB 138 or the BTB 140 to predict a next fetch group address 308 to be a branch address 310 which is 0x53dac8. The branch address 310 may also be referred to as a target address 312 or a predicted-taken branch 314 in relation to the conditional branch instruction 306. If the condition evaluates to false, the next fetch group address 308 is 0x53db10. Prior to evaluation of the conditional branch instruction 306, the instruction fetch circuit 110 may not hit in the HBTB 138 or the BTB 140. In that case, a next fetch group address 316 is determined by incrementing the fetch group program counter to address 0x53db10.

FIG. 4A is a block diagram of an exemplary HBTB, such as the HBTB 138 of FIG. 1, illustrating the indexing into the HBTB 138 for the exemplary instruction stream 300 of FIG. 3. The HBTB 138 may be a single way or multi-way table. For convenience, the HBTB 138 is shown as a single way table. The HBTB 138 has at least three columns: a fetch group address concatenated with global branch history column (FGA+GBH column) 400, an optional confidence counter column 402, and a HBTB hit information column 404 which includes a target address 408 of the next fetch group. The FGA+GBH column 400 includes entries of tags, such as an FGA+GBH tag 406. The FGA+GBH tag 406 includes bits from a fetch group address that contained a branch instruction in the past concatenated with bits of the global branch history register 210 which were taken at the time the branch instruction was confirmed. The optional confidence counter column 402 includes fields associated with a corresponding FGA+GBH tag 406. The optional confidence counter column 402 may be a 4 bit counter, for example, whose value may be above or below a value stored in a confidence threshold register. The instruction fetch circuit 110 utilizes the optional confidence counter column 402 to determine whether to utilize the target address 408 for the next fetch group stored in the corresponding HBTB hit information column 404. FIG. 4B is a block diagram of an exemplary confidence threshold register 410 of the instruction processing circuit 104 of FIG. 1.

FIG. 3 will be used as an example of indexing into the HBTB 138 to determine the target address of the next fetch group. At the time the instruction fetch circuit 110 receives the fetch group address 304, which is 0x53daec, the instruction fetch circuit 110 masks out eight bits, “0xec”, from the fetch group address 304 and concatenates eight bits from the contents of the global branch history register 210. For example, the global branch history register 210 stored a value whose lower eight bits are Oxed. The instruction fetch circuit 110 determines if there is a hit in the FGA+GBH column 400. In this example, there is a match at row 412 where the FGA+GBH tag 406 equals 0xec+0xed and matches the “0xec” masked from the fetch group address concatenated with the “0xed”. As such, the BTB next predicted target address 212 may be the target address 408 which equals 0x53dac8 and is stored in the corresponding HBTB hit information column 404. The instruction fetch circuit 110 confirms the hit by comparing the confidence counter, “0x3”, of the hit entry with the value in the confidence threshold register 410 to determine whether to retrieve the target address 408 for the next fetch group. Since the confidence value is greater than the value stored in the confidence threshold register 410, the instruction fetch circuit 110 will retrieve the target address 408 from the HBTB hit information column 404 for the next fetch group.

The HBTB 138 is a small table and will preferably not duplicate entries in the BTB 140. As such, when the instruction fetch circuit 110 determines a hit in the HBTB 138, the BTB/HBTB target verification circuit 208 will eventually override the HBTB hit information column 404 if there is a hit in the BTB 140 and the hit in the BTB 140 is confirmed to have predicted correctly. Doing so improves the prediction of the BTB 140 since the corresponding entry in the HBTB 138 was originally based on branch history. More detail of the BTB/HBTB target verification circuit 208 will be discussed in connection with FIGS. 7A-7C.

FIG. 4C is a block diagram of an exemplary BTB, such as BTB 140 of FIG. 1, illustrating the indexing into the BTB 140 for the exemplary instruction stream 300 of FIG. 3 assuming there was a miss in the HBTB 138. The BTB 140 may be a single way or multi-way table. For convenience, the BTB 140 is shown as a single way table. The BTB 140 has at least two columns; a fetch group address column 414 including tag entries and a BTB hit information column 416 which includes a corresponding target address 420 for the next fetch group. The target address 420 for the next fetch group is typically for a taken branch since a not-taken branch would result from an increment to the fetch group program counter. The tags in the fetch group address column 414 include bits from a fetch group address that contained a branch instruction which has been processed in the past.

FIG. 3 will be used as an example of indexing into the BTB 140 to determine the target address 420 of the next fetch group assuming there was a miss in the HBTB 138. Since the fetch group address 304 is 0x53daec, the instruction fetch circuit 110 masks out eight bits, “0x3d”, from the fetch group address 304 and determines if there is a hit in the fetch group address column 414. In this example, there is a match at row 418 where the tag in row 418 equals “0x3d” and matches the “0x3d” masked from the fetch group address 304. As such, the BTB next predicted target address 308 would be the target address 420 which is stored in the corresponding BTB hit information column 416.

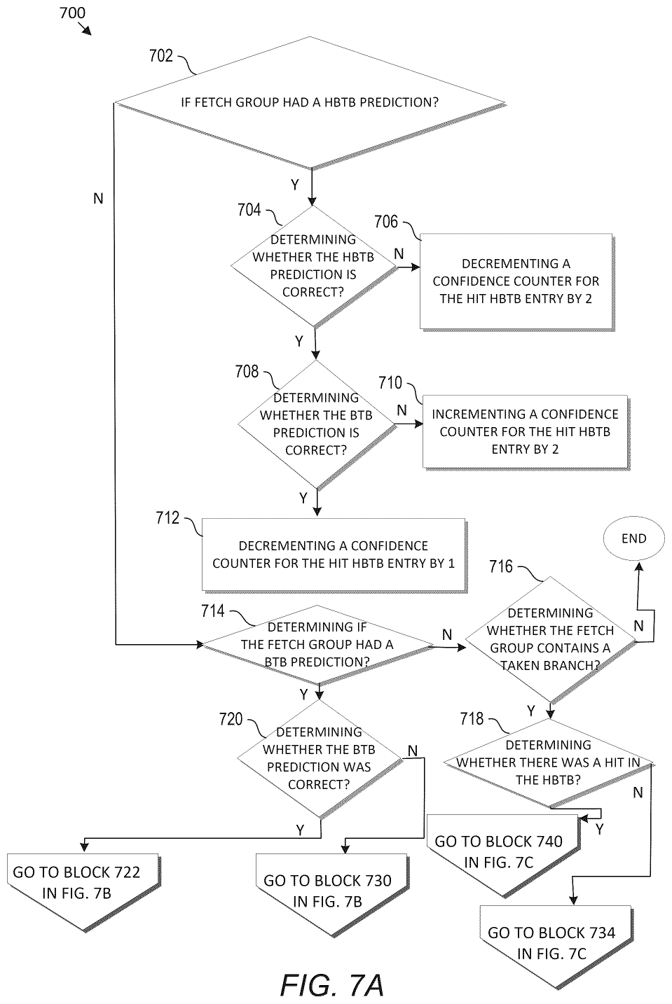

FIG. 5 is a flowchart illustrating exemplary method 500 for predictively fetching branches based on a fetch group address and branch history. A first exemplary operation in the exemplary operations 500 of FIG. 5 for predictively fetching branches based on a fetch group address and branch history early in an instruction fetch circuit can include providing a fetch group address 218, 304 comprising a group of instructions 302 to be fetched where one of the group of instructions is a conditional branch instruction 306 (block 502). The next step in the exemplary operations 500 can include providing a value 211 from the global branch history register 210 (block 504). The next step in the exemplary operations 500 can include providing a HBTB 138 (block 506). The next step in the exemplary operations 500 can include processing an instruction stream 106, 300 (block 508).

The next steps in the exemplary operations 500 are in response to the fetch group address 218, 304 and the value 211 from the global branch history register 210. The next step in the exemplary operations 500 may include indexing into the HBTB 138 (block 510,). The next step in the exemplary operations 500 may include determining whether there is a hit in the HBTB 138 (block 512). The next step in the exemplary operations 500 may include retrieving a target address 312, 408, 420 for a next fetch group 308, the next fetch group 308 comprising a plurality of fetched instructions from the instruction stream 300, wherein one of the plurality of fetched instructions is a predicted-taken branch 314 of the conditional branch instruction 306 (block 514).

FIG. 6 is a flowchart illustrating exemplary operations 600 in more detail of the instruction fetch circuit 110 of FIG. 1 for predictively fetching a branch based on a fetch group program counter and global branch history. A first exemplary operation in the exemplary operations 600 of FIG. 6 for predictively fetching branches based on a fetch group address and branch history early in an instruction fetch circuit can include indexing into the HBTB 138 and BTB 140 (block 602). Indexing into the HBTB 138 was described in connection with FIG. 4A. Indexing into the BTB 140 was described in connection with FIG. 4B. The next step in the exemplary operations 600 may include determining whether there is a hit in the HBTB 138 (block 604). If there is a hit in the HBTB 138, the next step in the exemplary operations 600 may include determining if a confidence counter in the hit entry in the HBTB 138 is greater than a confidence threshold such as a confidence threshold stored in the exemplary confidence threshold register 410 (block 606). If the confidence counter is greater than the confidence threshold, the next step in the exemplary operations 600 may include retrieving a target address for the next fetch group address from the hit entry in the HBTB 138 and override the BTB_HIT_INFO in a corresponding entry in the BTB 140 (block 608). Returning to blocks 604, 606, if the conditions in block 604, 606 are negative, the next step in the exemplary operations 600 may include determining whether there is a hit in the BTB 140 (block 610). If there is not a hit in the BTB 140, the next fetch group address is determined by something else such as incrementing a fetch group program counter. If there is a hit in the BTB 140 (i.e., a hit BTB entry), the next step in the exemplary operations 600 may include retrieving a target address for the next fetch group address which is stored in the hit BTB entry (block 612).

FIGS. 7A-7C is a flowchart illustrating exemplary verification operations 700 of the instruction fetch circuit 110 in FIGS. 1-2, and more particularly, the BTB/HBTB target verification circuit 208 in FIG. 2, to train the entries in the HBTB 138 and BTB 140 in FIG. 1 to predictively fetch a branch based on a fetch group program counter and global branch history. After a fetch group of instructions has been fetched from the Icache 112, the BTB/HBTB target verification circuit 208 verifies whether the prediction that resulted from the fetch group which is present in the BTB/HBTB target verification circuit 208 was correct. An exemplary step in the exemplary operations 700 may include determining if the fetch group had a HBTB prediction (block 702, FIG. 7A). In other words, there was a hit in the HBTB 138 resulting in a hit HBTB entry. If the fetch group had an HBTB prediction, the next step in the exemplary operations 700 may include determining whether the HBTB prediction was correct (block 704, FIG. 7A). For example, a correct HBTB prediction occurs when the previous fetch group address hits in the HBTB and, if the hit HBTB entry has a confidence counter, the confidence counter exceeds a threshold. An example of an incorrect HBTB prediction may include correctly indexing into the HBTB 138, but a target address associated with a hit entry does not equal the address of the fetch group being processed by the BTB/HBTB target verification circuit 208. If the HBTB prediction was incorrect, the next step in the exemplary operations 700 may include decrementing a confidence counter for the hit HBTB entry by two (2) (block 706, FIG. 7A). This path through the exemplary operations 700 means that this hit HBTB entry did not predict properly. Please note that all the increments/decrements of confidence counters discussed in FIGS. 7A-7C are based on a 4-bit confidence counter and 4-bit confidence counter threshold register. The increments/decrements would change accordingly if a larger or smaller confidence counter and a confidence threshold register were used.

If the HBTB prediction was correct, the next step in the exemplary operations 700 may include determining whether the BTB prediction is correct (block 708, FIG. 7). If the BTB prediction is incorrect, the next step in the exemplary operations 700 may include incrementing a confidence counter for the hit HBTB entry by two (2) (block 710, FIG. 7A). This path through the exemplary operations 700 means that this hit HBTB entry did predict properly while the BTB prediction was incorrect. As such, the hit HBTB entry is strengthened. If the BTB prediction is correct, the next step in the exemplary operations 700 may include decrementing a confidence counter for the hit HBTB entry by one (1) (block 712, FIG. 7A). This path through the exemplary operations 700 means that the BTB prediction is working properly and that more reliance can be placed on the BTB prediction.

Returning to block 702, if the fetch group did not have a HBTB prediction, the next step in the exemplary operations 700 may include determining if the fetch group had a BTB prediction (block 714, FIG. 7A). If the fetch group did not have a BTB prediction, the next step in the exemplary operations 700 may include determining whether the fetch group contains a taken branch (block 716, FIG. 7A). If the fetch group does not contain a taken branch, the exemplary operation 700 ends. If the fetch group does contain a taken branch, the next step in the exemplary operations 700 may include determining whether there was a hit in the HBTB 138 (block 718, FIG. 7). If there was a hit in the HBTB 138, the next step in the exemplary operations 700 may proceed to block 740 which will be described later. If there was not a hit in the HBTB 138, the next step in the exemplary operations 700 may proceed to block 734 which will be described later.

Returning to block 714, if the fetch group did have a prediction, the next step in the exemplary operations 700 may include determining whether the BTB prediction is correct (block 720, FIG. 7A). If the BTB prediction was correct, the next step in the exemplary operations 700 may include determining whether there was a hit in the HBTB 138 (block 722, FIG. 7B). If the BTB prediction was not correct, the next step in the exemplary operations may proceed to block 730 which will be described later.

Returning to block 722, if there was not a hit in the HBTB 138, the exemplary operations 700 ends. If there was a hit in the HBTB 138, the next step in the exemplary operations 700 may include determining whether the hit in the HBTB 138 was correct (block 724, FIG. 7B). If the hit in the HBTB 138 was not correct, the next step in the exemplary operations 700 may include decrementing a confidence counter of the HBTB entry by two (2) (block 726, FIG. 7B). If the hit in the HBTB 138 was correct, the next step in the exemplary operations 700 may include decrementing a confidence counter of the HBTB entry by one (1) (block 728, FIG. 7B). The confidence counter of the HBTB entry is decremented because, in this path, there was also a correct prediction in the BTB 140. By decrementing the HBTB entry, further reliance is put on the correct prediction in the BTB 140 while increasing the probability that this HBTB entry will be replaced.

Returning block 720 in FIG. 7A, if the BTB prediction was not correct, the next step in the exemplary operations 700 may include determining whether there was a hit in the HBTB 138 (block 730, FIG. 7B). If there was not a hit in the HBTB 138, the next step in the exemplary operations 700 may include determining whether there is a taken branch in the fetch group (block 732, FIG. 7B). If there is not a taken branch in the fetch group, there is no modification to the HBTB 138 or the BTB 140 and the process for this fetch group ends. If there is a taken branch in the fetch group, the next step in the exemplary operations 700 may include determining whether there is any HBTB entry in the HBTB 138 which has a confidence counter equal to 0 (block 734, FIG. 7C). This determination is calculated using the fetch group address of the fetch group. If there is not any HBTB entry in the HBTB 138 which has a confidence counter equal to 0, the next step in the exemplary operations 700 may include decrementing all confidence counters in all HBTB entries by one (1) (block 736, FIG. 7C). If there is an HBTB entry in the HBTB 138 which has a confidence counter equal to 0, the next step in the exemplary operations 700 may include replacing the FGA+GBH tag of a first entry in the HBTB 138 with a confidence counter equal 0 with a tag formed by concatenating the address of the fetch group and a current value of the global branch history register 210 (block 738, FIG. 7C).

Returning to block 730, FIG. 7B, if there was a hit in the HBTB 138, the next step in the exemplary operations 700 may include determining whether the hit in the HBTB 138 was correct (block 740, FIG. 7C). If the hit in the HBTB 138 was not correct, the next step in the exemplary operations 700 may include decrementing a confidence counter of the hit HBTB entry by two (2) (block 742, FIG. 7C). If the hit in the HBTB 138 was correct, the next step in the exemplary operations 700 may include incrementing the confidence counter of the hit HBTB entry by two (2) (block 744, FIG. 7C).

Electronic devices that include a processor-based device that includes a processor with an instruction processing circuit that includes an instruction fetch circuit that predictively fetches branches based on a fetch group address and branch history as disclosed in aspects described herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

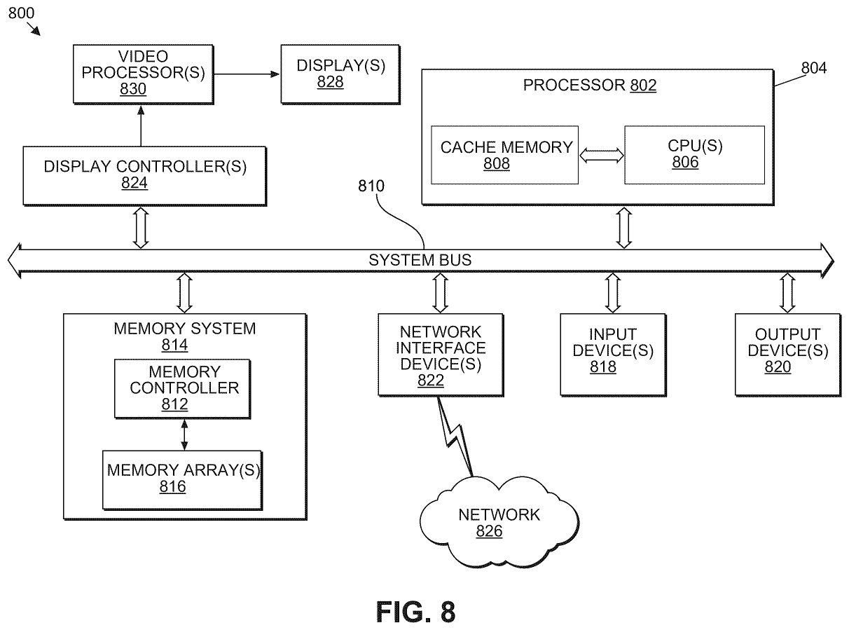

In this regard, FIG. 8 is a block diagram of an exemplary processor-based system 800 that can include the instruction fetch circuit 110 of FIGS. 1 and 2, and according to exemplary processes of FIGS. 5, 6, and 7A-7C which is configured to predictively fetch branches based on a fetch group address and branch history.

In this example, the processor-based system 800 includes a processor 802 deployed on a semiconductor die 804. The processor 802 includes one or more central processing units (captioned as “CPUs” in FIG. 9) 806, which may also be referred to as CPU cores or processor cores. The processor 802 may have cache memory 808 coupled to the processor 802 for rapid access to temporarily stored data. The processor 802 is coupled to a system bus 810 and can intercouple server and client devices included in the processor-based system 800. As is well known, the processor 802 communicates with these other devices by exchanging address, control, and data information over the system bus 810. For example, the processor 802 can communicate bus transaction requests to a memory controller 812, as an example of a client device. Although not illustrated in FIG. 8, multiple system buses 810 could be provided, wherein each system bus 810 constitutes a different fabric.

Other server and client devices can be connected to the system bus 810 and deployed in the semiconductor die 804. As illustrated in FIG. 8, these devices can include a memory system 814 that includes the memory controller 812 and a memory array(s) 816, one or more input devices 818, one or more output devices 820, one or more network interface devices 822, and one or more display controllers 824, as examples. The input device(s) 818 can include any type of input device, including but not limited to input keys, switches, voice processors, etc. The output device(s) 820 can include any type of output device, including, but not limited to, audio, video, other visual indicators, etc. The network interface device(s) 822 can be any device configured to allow exchange of data to and from a network 826. The network 826 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 822 can be configured to support any type of communications protocol desired.

The processor 802 may also be configured to access the display controller(s) 824 over the system bus 810 to control information sent to one or more displays 828. The display controller(s) 824 sends information to the display(s) 828 to be displayed via one or more video processors 830, which process the information to be displayed into a format suitable for the display(s) 828. The display controller(s) 824 and/or the video processors 830 may comprise or be integrated into a GPU. The display(s) 828 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor-based device, comprising:
a fetch group address of a fetch group, the fetch group comprising a group of instructions to be fetched where one of the group of instructions is a branch instruction;
a global branch history;
a history-based branch target buffer (HBTB);
an instruction processing circuit configured to process an instruction stream; and
the instruction processing circuit comprising an instruction fetch circuit, in response to the fetch group address and the global branch history, configured to:
   index into the HBTB;
   determine whether there is a hit in the HBTB;
   in response to the hit in the HBTB, retrieve a target address for a next fetch group, the next fetch group comprising a plurality of fetched instructions from the instruction stream, wherein one of the plurality of fetched instructions is a predicted-taken branch of the branch instruction.
      2. The processor-based device of clause 1, wherein the HBTB, further comprises: a tag comprising:
a first portion of a first previous fetch group address; and
a second portion of a first previous global branch history.
   3. The processor-based device of clause 1 or 2, further comprising:
a confidence threshold register,
wherein the HBTB further comprises:
   a confidence counter,
wherein the fetch group address and the global branch history are matched with the first portion of the first previous fetch group address and the second portion of the first previous global branch history, the instruction fetch circuit further configured to:
   determine whether the confidence counter is greater than a confidence threshold stored in the confidence threshold register.
      4. The processor-based device of clause 3, wherein:
the HBTB further comprises:
   the target address for the next fetch group;
the confidence counter is greater than the confidence threshold; and
the instruction fetch circuit, in response to the fetch group address and the global branch history, configured to retrieve the target address for the next fetch group, is further configured to:
   retrieve the target address for the next fetch group from the HBTB.
      5. The processor-based device of clause 3, wherein:
the confidence counter is less than or equal to the confidence threshold; and
the instruction fetch circuit, in response to the fetch group address and the global branch history, configured to retrieve the target address for the next fetch group, is further configured to:
   retrieve the target address for the next fetch group from a branch target buffer (BTB).
      6. The processor-based device of any of clauses 1-5, further comprising: an instruction cache,
wherein the instruction fetch circuit is further configured to:
   verify whether the target address for the next fetch group was properly predicted after the group of instructions at the fetch group address were fetched from the instruction cache.
      7. The processor-based device of clause 6,
wherein the instruction fetch circuit configured to verify whether the target address for the next fetch group was properly predicted after the group of instructions at the fetch group address were fetched from the instruction cache, is further configured to:
   determine whether the fetch group had a HBTB prediction;
      in response to the fetch group having the HBTB prediction, determine whether the HBTB prediction is correct;
         in response to the HBTB prediction not being correct, decrement a confidence counter for a hit HBTB entry from the HBTB prediction;
         in response to the HBTB prediction being correct, determine whether a branch target buffer (BTB) prediction of the fetch group is correct;
         in response to the BTB prediction of the fetch group not being correct, increment the confidence counter for the hit HBTB entry; and
         in response to the BTB prediction for the fetch group being correct, decrement the confidence counter for the hit HBTB entry.
            8. The processor-based device of any of clauses 1-7, integrated into a device selected from the group consisting of:
a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
   9. A processor-based device, comprising:
a fetch group address of a fetch group, the fetch group comprising a group of instructions to be fetched where one of the group of instructions is a branch instruction;
a global branch history;
a history-based branch target buffer (HBTB);
means for processing an instruction stream;
the means for processing the instruction stream, in response to the fetch group address and the global branch history, comprising:
   means for indexing into the HBTB;
   means for determining whether there is a hit in the HBTB; and
   in response to the hit in the HBTB,
      means for retrieving a target address for a next fetch group, the next fetch group comprising a plurality of fetched instructions from the instruction stream, wherein one of the plurality of fetched instructions is a predicted-taken branch of the branch instruction.
         10. A method for predictively fetching branches based on a fetch group address and branch history, comprising:
providing the fetch group address of a fetch group, the fetch group comprising a group of instructions to be fetched where one of the group of instructions is a branch instruction;
providing a global branch history;
providing a history-based branch target buffer (HBTB);
processing an instruction stream; and
in response to the fetch group address and the global branch history: indexing into the HBTB;
   determining whether there is a hit in the HBTB; and
   retrieving a target address for a next fetch group, the next fetch group comprising a plurality of fetched instructions from the instruction stream, wherein one of the plurality of fetched instructions is a predicted taken branch of the branch instruction.
      11. The method of clause 10, wherein the HBTB further comprises:
a tag comprising:
   a first portion of a first previous fetch group address; and
   a second portion of a first previous global branch history.
      12. The method of clause 10 or 11, further comprising:
matching the fetch group address and the global branch history with the first portion of the first previous fetch group address and the second portion of the first previous global branch history to obtain a hit HBTB entry in the HBTB; and
determining whether a confidence counter in the hit HBTB entry is greater than a confidence threshold.
   13. The method of clause 12, further comprising, in response to the confidence counter in the hit HBTB entry being greater than the confidence threshold:
retrieving the target address for the next fetch group from the HBTB.
   14. The method of clause 12, further comprising, in response to the confidence counter in the hit HBTB entry being less than or equal to the confidence threshold:
retrieving the target address for the next fetch group from a branch target buffer (BTB).
   15. The method of any of clauses 10-14, further comprising:
verifying whether the target address for the next fetch group was properly predicted after the group of instructions at the fetch group address were fetched from an instruction cache.
   16. The method of clause 15,
wherein verifying whether the target address for the next fetch group was properly predicted after the group of instructions at the fetch group address were fetched from the instruction cache, further comprises:
   determining whether the fetch group had a HBTB prediction.
      17. The method of clause 16, in response to the fetch group having the HBTB prediction, further comprising:
determining whether the HBTB prediction is correct.
   18. The method of clause 17, in response to the HBTB prediction not being correct, further comprising:
decrementing a confidence counter for a hit HBTB entry from the HBTB prediction.
   19. The method of clause 17, in response to the HBTB prediction being correct, further comprising:
determining whether a branch target buffer (BTB) prediction of the fetch group is correct.
   20. The method of clause 19, in response to the BTB prediction of the fetch group not being correct, further comprising:
incrementing a confidence counter for a hit HBTB entry from the HBTB prediction; and
in response to the BTB prediction for the fetch group being correct: decrementing the confidence counter for the hit HBTB entry.

1. A processor-based device, comprising:
a fetch group address of a fetch group, the fetch group comprising a group of instructions to be fetched where one of the group of instructions is a branch instruction;
a global branch history;
a history-based branch target buffer (HBTB);
an instruction processing circuit configured to process an instruction stream; and
the instruction processing circuit comprising an instruction fetch circuit, in response to the fetch group address and the global branch history, configured to:
index into the HBTB;
determine whether there is a hit in the HBTB;
in response to the hit in the HBTB, retrieve a target address for a next fetch group, the next fetch group comprising a plurality of fetched instructions from the instruction stream, wherein one of the plurality of fetched instructions is a predicted-taken branch of the branch instruction,
wherein the HBTB, further comprises:
a tag comprising:
a first portion of a first previous fetch group address; and
a second portion of a first previous global branch history.

2. (canceled)

3. The processor-based device of claim 1, further comprising:
a confidence threshold register,
wherein the HBTB further comprises:
a confidence counter,
wherein the fetch group address and the global branch history are matched with the first portion of the first previous fetch group address and the second portion of the first previous global branch history, the instruction fetch circuit further configured to:
determine whether the confidence counter is greater than a confidence threshold stored in the confidence threshold register.

4. The processor-based device of claim 3, wherein:
the HBTB further comprises:
the target address for the next fetch group;
the confidence counter is greater than the confidence threshold; and
the instruction fetch circuit, in response to the fetch group address and the global branch history, configured to retrieve the target address for the next fetch group, is further configured to:
retrieve the target address for the next fetch group from the HBTB.

5. The processor-based device of claim 3, wherein:
the confidence counter is less than or equal to the confidence threshold; and
the instruction fetch circuit, in response to the fetch group address and the global branch history, configured to retrieve the target address for the next fetch group, is further configured to:
retrieve the target address for the next fetch group from a branch target buffer (BTB).

6. The processor-based device of claim 1, further comprising:
an instruction cache,
wherein the instruction fetch circuit is further configured to:
verify whether the target address for the next fetch group was properly predicted after the group of instructions at the fetch group address were fetched from the instruction cache.

7. The processor-based device of claim 6,
wherein the instruction fetch circuit configured to verify whether the target address for the next fetch group was properly predicted after the group of instructions at the fetch group address were fetched from the instruction cache, is further configured to:
determine whether the fetch group had a HBTB prediction;
in response to the fetch group having the HBTB prediction, determine whether the HBTB prediction is correct;
in response to the HBTB prediction not being correct, decrement a confidence counter for a hit HBTB entry from the HBTB prediction;
in response to the HBTB prediction being correct, determine whether a branch target buffer (BTB) prediction of the fetch group is correct;
in response to the BTB prediction of the fetch group not being correct, increment the confidence counter for the hit HBTB entry; and
in response to the BTB prediction for the fetch group being correct, decrement the confidence counter for the hit HBTB entry.

8. The processor-based device of claim 1, integrated into a device selected from the group consisting of:
a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

9. A processor-based device, comprising:
a fetch group address of a fetch group, the fetch group comprising a group of instructions to be fetched where one of the group of instructions is a branch instruction;
a global branch history;
a history-based branch target buffer (HBTB);
means for processing an instruction stream;
the means for processing the instruction stream, in response to the fetch group address and the global branch history, comprising:
means for indexing into the HBTB;
means for determining whether there is a hit in the HBTB; and
in response to the hit in the HBTB,
means for retrieving a target address for a next fetch group, the next fetch group comprising a plurality of fetched instructions from the instruction stream, wherein one of the plurality of fetched instructions is a predicted-taken branch of the branch instruction,
wherein the HBTB, further comprises:
a tag comprising:
a first portion of a first previous fetch group address; and
a second portion of a first previous global branch history.

10. A method for predictively fetching branches based on a fetch group address and branch history, comprising:
providing the fetch group address of a fetch group, the fetch group comprising a group of instructions to be fetched where one of the group of instructions is a branch instruction;
providing a global branch history;
providing a history-based branch target buffer (HBTB);
processing an instruction stream; and
in response to the fetch group address and the global branch history:
indexing into the HBTB;
determining whether there is a hit in the HBTB; and
retrieving a target address for a next fetch group, the next fetch group comprising a plurality of fetched instructions from the instruction stream, wherein one of the plurality of fetched instructions is a predicted taken branch of the branch instruction,
wherein the HBTB further comprises:
a tag comprising:
a first portion of a first previous fetch group address; and
a second portion of a first previous global branch history.

11. (canceled) The method of claim 10, wherein the HBTB further comprises:
a tag comprising:
a first portion of a first previous fetch group address; and
a second portion of a first previous global branch history.

12. The method of claim 10, further comprising:
matching the fetch group address and the global branch history with the first portion of the first previous fetch group address and the second portion of the first previous global branch history to obtain a hit HBTB entry in the HBTB; and
determining whether a confidence counter in the hit HBTB entry is greater than a confidence threshold.

13. The method of claim 12, further comprising, in response to the confidence counter in the hit HBTB entry being greater than the confidence threshold:
retrieving the target address for the next fetch group from the HBTB.

14. The method of claim 12, further comprising, in response to the confidence counter in the hit HBTB entry being less than or equal to the confidence threshold:
retrieving the target address for the next fetch group from a branch target buffer (BTB).

15. The method of claim 10, further comprising:
verifying whether the target address for the next fetch group was properly predicted after the group of instructions at the fetch group address were fetched from an instruction cache.

16. The method of claim 15,
wherein verifying whether the target address for the next fetch group was properly predicted after the group of instructions at the fetch group address were fetched from the instruction cache, further comprises:
determining whether the fetch group had a HBTB prediction.

17. The method of claim 16, in response to the fetch group having the HBTB prediction, further comprising:
determining whether the HBTB prediction is correct.

18. The method of claim 17, in response to the HBTB prediction not being correct, further comprising:
decrementing a confidence counter for a hit HBTB entry from the HBTB prediction.

19. The method of claim 17, in response to the HBTB prediction being correct, further comprising:
determining whether a branch target buffer (BTB) prediction of the fetch group is correct.

20. The method of claim 19, in response to the BTB prediction of the fetch group not being correct, further comprising:
incrementing a confidence counter for a hit HBTB entry from the HBTB prediction; and
in response to the BTB prediction for the fetch group being correct:
decrementing the confidence counter for the hit HBTB entry.
